(19) United States
(12) Patent Application Publication
(10) Pub. No.: US 2024/0104403 A1
(43) Pub. Date: Mar. 28, 2024

(54) METHOD FOR TRAINING CLICK RATE PREDICTION MODEL

(71) Applicant: BEIJING BAIDU NETCOM SCIENCE TECHNOLOGY CO., LTD., Beijing (CN)

(72) Inventors: Yaqing Wang, Beijing (CN); Hongming Piao, Beijing (CN); Longteng Xu, Beijing (CN); Daxiang Dong, Beijing (CN); Jingbo Zhou, Beijing (CN)

(73) Assignee: BEIJING BAIDU NETCOM SCIENCE TECHNOLOGY CO., LTD., Beijing (CN)

(21) Appl. No.: 18/521,061

(22) Filed: Nov. 28, 2023

(30) Foreign Application Priority Data
May 4, 2023 (CN) 202310491836.5

(51) Int. Cl. G06N 5/022

(52) U.S. Cl. CPC G06N 5/022

(57) ABSTRACT

A method for training a click rate prediction model includes: obtaining sample feature information and a label value, in which the sample feature information includes feature information of a sample user and feature information of a target object, and the label value is configured to indicate whether the sample user interacts with the target object; obtaining a plurality of adjacent matrixes for feature interaction by processing the feature information of the target object based on the hypernetwork module; obtaining a click rate prediction value of the sample user on the target object using the prediction module, according to the sample feature information and the plurality of adjacent matrixes; and training the click rate prediction model according to the label value and the click rate prediction value.

### CROSS-REFERENCE TO RELATED APPLICATION

This application claims the priority to Chinese Patent Application No. 202310491836.5, filed on May 4, 2023, the entire contents of which are incorporated herein by reference in their entireties.

### TECHNICAL FIELD

The disclosure relates to a field of data processing technologies, especially to the fields of artificial intelligence (AI), natural language processing (NLP), deep learning and smart search, in particular to a method for training a click rate prediction model, a click rate prediction method and an electronic device.

### BACKGROUND

A click rate prediction task is a task of predicting a probability of a user clicking on an item according to features of the user and the item. Accurate click rate prediction can recommend the most proper items for the user and improve user experience. However, in the case where an amount of data of items available for training is very small, for example, at an early stage of emergence of a new item, a traditional click rate prediction model is less effective in predicting a click rate, and it is difficult to accurately recommend appropriate items to the user based on a prediction result, i.e., there is a cold start problem on the item side. Therefore, there is an urgent need to quickly improve the click rate prediction accuracy by utilizing a small amount of item data, to recommend appropriate items to the user.

### SUMMARY

According to a first aspect of the disclosure, a method for training a click rate prediction model is provided. The click rate prediction model includes a hypernetwork module and a prediction module. The method includes:
obtaining sample feature information and a label value, in which the sample feature information includes feature information of a sample user and feature information of a target object, and the label value is configured to indicate whether the sample user interacts with the target object;
obtaining a plurality of adjacent matrixes for feature interaction by processing the feature information of the target object based on the hypernetwork module;
obtaining a click rate prediction value of the sample user on the target object using the prediction module, according to the sample feature information and the plurality of adjacent matrixes; and
training the click rate prediction model according to the label value and the click rate prediction value.

According to a second aspect of the disclosure, a click rate prediction method is provided. The method includes:
obtaining feature information of a user and feature information of a target object;
inputting the feature information of the user and the feature information of the target object into a pre-trained click rate prediction model, in which the click rate prediction model is obtained by training using the method according to the first aspect; and
obtaining a click rate prediction value output by the click rate prediction model, and determining the click rate prediction value as a probability of the user interacting with the target object.

According to a third aspect of the disclosure, an electronic device is provided. The electronic device includes:
at least one processor; and
a memory communicatively connected to the at least one processor; in which
the memory stores instructions executable by the at least one processor, and when the instructions are executed by the at least one processor, the at least one processor is caused to implement the method according to the first aspect or the method according to the second aspect.

According to a fourth aspect of the disclosure, a non-transitory computer-readable storage medium having computer instructions stored thereon is provided. The computer instructions are configured to cause a computer to implement the method according to the first aspect or the method according to the second aspect.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart of a method for training a click rate prediction model according to an embodiment of the disclosure.

FIG. 2 is a flowchart of a method for training a click rate prediction model according to an embodiment of the disclosure.

FIG. 3 is a schematic diagram of a click rate prediction model according to an embodiment of the disclosure.

FIG. 4 is a flowchart of a method for training a click rate prediction model according to an embodiment of the disclosure.

FIG. 5 is a flowchart of a click rate prediction method according to an embodiment of the disclosure.

FIG. 6 is a block diagram of an apparatus for training a click rate prediction model according to an embodiment of the disclosure.

FIG. 7 is a block diagram of an apparatus for training a click rate prediction model according to an embodiment of the disclosure.

FIG. 8 is a block diagram of a click rate prediction apparatus according to an embodiment of the disclosure.

FIG. 9 is a block diagram of an electronic device for implementing the method for training a click rate prediction model or the click rate prediction method according to an embodiment of the disclosure.

### DETAILED DESCRIPTION

The following describes the embodiments of the disclosure with reference to the accompanying drawings, which includes various details of the embodiments of the disclosure to facilitate understanding, which shall be considered merely exemplary. Therefore, those skilled in the art should recognize that various changes and modifications can be made to the embodiments described herein without departing from the scope and spirit of the disclosure. For clarity and conciseness, descriptions of well-known functions and structures are omitted in the following description.

The terms used in the embodiments of the disclosure are only for the purpose of describing specific embodiments, and are not intended to limit the embodiments of the disclosure. The singular forms of “a” and “the” used in the embodiments of the disclosure and appended claims are also intended to include plural forms, unless the context clearly indicates other meanings.

It should be understood that although the terms “first”, “second”, and “third” may be used in the embodiments of the disclosure to describe various information, the information should not be limited to these terms. These terms are only used to distinguish the same type of information from each other. For example, without departing from the scope of the disclosure, the first information may also be referred to as the second information, and similarly, the second information may also be referred to as the first information. Depending on the context, the term “if” as used herein can be interpreted as “when”, “while” or “in response to determining”.

It should be noted that the collection, storage, usage, processing, transmission, provision and disclosure of the user's personal information involved in the technical solutions of the disclosure are handled in accordance with relevant laws and regulations and are not contrary to public order and morals.

In a click rate prediction task, finding suitable feature interactions often requires a large amount of data, the feature interactions are able to fuse different feature information to generate new information, which improves a click rate prediction accuracy. However, for new items or a situation where only a small amount of item sample data is available, it is difficult to quickly perform feature interactions in the click rate prediction task, and the click rate prediction effect is poor. Therefore, the disclosure provides a method for training a click rate prediction model and an apparatus for training a click rate prediction model. In detail, the method for training a click rate prediction model and the apparatus for training a click rate prediction model of the embodiments of the disclosure are described below with reference to the accompanying drawings.

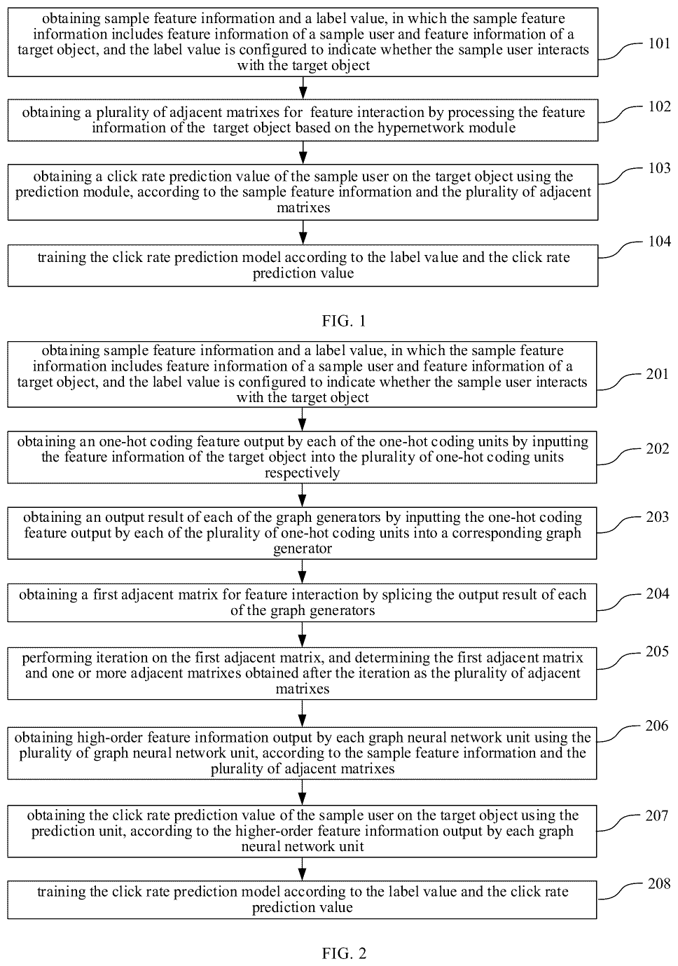

FIG. 1 is a flowchart of a method for training a click rate prediction model according to an embodiment of the disclosure. The click rate prediction model includes a hypernetwork module and a prediction module. It is noted that the method for training a click rate prediction model according to the embodiments of the disclosure can be performed by the apparatus for training a click rate prediction model according to the embodiments of the disclosure, which may be configured on an electronic device. It should also be noted that the click rate prediction model may be used in recommendation, search, and other related scenarios, to provide a user with graphic personalized recommendation, media personalized recommendation services, and the like. As illustrated in FIG. 1, the method for training a click rate prediction model may include, but is not limited to, the following steps.

At step 101, sample feature information and a label value are obtained, in which the sample feature information includes feature information of a sample user and feature information of a target object, and the label value is configured to indicate whether the sample user interacts with the target object.

The feature information of the sample user may include feature information, such as an ID of the user, user's age, user's interest, and the like. The target object may be an item, a commodity, or an advertisement. The feature information of the target object may be feature information such as an ID of the target object, a type of the target object, and an attribute of the target object. The label value ŷ_{i,j} ∈{0,1} is configured to indicate whether there is an interactive behavior between the sample user and the target object. The interactive behavior may be operations such as clicking, purchasing, sharing, and collecting performed on the target object by the sample user.

In some embodiments of the disclosure, the sample feature information can be the sample feature information h₁⁽⁰⁾ . . . h_{N}_{ᵥ}⁽⁰⁾+Nᵤ obtained by transforming discrete original feature information into a dense space through a feature embedding process, in which, hₘ⁽⁰⁾, m ∈ [1, 2, . . . , Nᵥ+Nᵤ] represents the m^{th} sample feature information, Nᵥ represents an amount of the feature information of the target object, and Nᵤ represents an amount of the feature information of the sample user.

At step 102, a plurality of adjacent matrixes for feature interaction are obtained by processing the feature information of the target object based on the hypernetwork module.

It is noted that the adjacent matrix represent feature graphs, and are used to represent feature interaction patterns, in which nodes represent features and edges represent correlations among the features. In a possible implementation, the hypernetwork module may generate a plurality of adjacent matrixes for feature interaction through a plurality of graph generators. The adjacent matrixes represent feature interaction patterns exclusive to the target object, so that the feature interaction can be quickly optimized according to a small amount of sample data under a few-short learning condition .

At step 103, a click rate prediction value of the sample user on the target object is obtained using the prediction module, according to the sample feature information and the plurality of adjacent matrixes.

In a possible implementation, the sample feature information can determine a neighboring feature according to the adjacent matrixes and may be fused with the neighboring feature to perform feature interaction, to obtain high-order feature information. Further, according to the higher-order feature information, the prediction module is used to predict a click rate, to obtain the click rate prediction value of the sample user on the target object.

At step 104, the click rate prediction model is trained according to the label value and the click rate prediction value.

Optionally, in some embodiments of the disclosure, a loss function may be calculated according to the label value and the click rate prediction value. According to the loss function, a model parameter of the hypernetwork module and a model parameter of the prediction module are adjusted. As an example, the click rate prediction model may be trained using meta-learning, a training process of the meta-learning may be completed by transferring a loss function gradient to a meta-learner for updating, and the model parameters are optimized using an Adam optimizer. An optimization objective may be shown below:

$${θ}_{GNN}^{*} , {θ}_{hyper}^{*} = arg {min}_{{θ}_{GNN} , {θ}_{hyper}} {L}_{meta} ( {θ}_{GNN} , {θ}_{hyper} )$$

$$s . t . {ϕ}_{i}^{*} ( {θ}_{hyper} ) = arg {min}_{{ϕ}_{i}} {L}_{{s}_{i}} ( {θ}_{GNN} , {ϕ}_{i} )$$

where, θ*_{GNN} represents the model parameter of the prediction module, θ*_{hyper} represents the model parameter of the hypernetwork module, Lₘₑₜₐ represents a loss function of the meta-learning, L_{S}_{ᵢ} represents a loss function exclusive to each task, and ϕᵢ represents a target object ID embedding exclusive to a target object i and an adjacent matrix exclusive to the target object i. Optionally, the loss function may be cross-entropy. Therefore, the corresponding adjacent matrixes for feature interaction may be generated using the hypernetwork module when the target object first appears. As the amount of target object data available for training gradually increases, the adjacent matrixes may be gradually optimized by gradient descent, and ultimately an optimal feature interaction pattern for the target object can be generated. Therefore, under the few-short learning condition, the feature information of the target object and the feature information of the user can quickly find suitable features for interaction based on the feature interaction pattern.

By implementing the embodiments of the disclosure, the adjacent matrixes for feature interaction of the target object, i.e., the feature interaction patterns exclusive to the target object, can be generated based on the hypernetwork module, click rates can be predicted according to the adjacent matrixes and the click rate prediction model can be trained. Therefore, a click rate prediction accuracy of the click rate prediction model can be rapidly improved under the few-short learning condition, to alleviate the cold-start problem in the click rate prediction task to some extent. Effective recommendations can be subsequently provided to the user based on a predicted click rate, thereby improving the user experience.

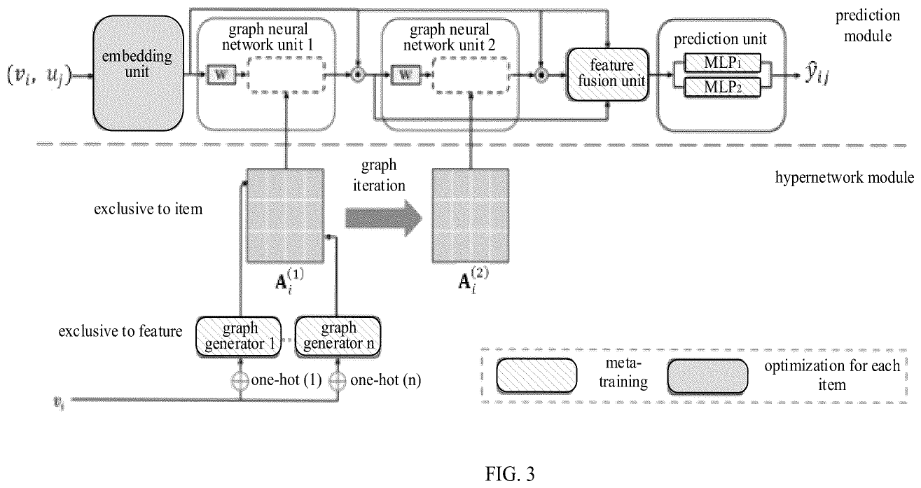

FIG. 2 is a flowchart of a method for training a click rate prediction model according to an embodiment of the disclosure. As illustrated in FIG. 3, a hypernetwork module in the click rate prediction model includes a plurality of one-hot coding units and graph generators corresponding to the plurality of one-hot coding units respectively. The prediction module in the click rate prediction model includes a plurality of graph neural network units and a prediction unit, a number of the graph neural network units is the same as a number of a plurality of adjacent matrixes, and each graph neural network unit corresponds to one of the plurality of adjacent matrixes. As illustrated in FIG. 2, the method for training a click rate prediction model may include but is not limited to the following steps.

At step 201, sample feature information and a label value are obtained, in which the sample feature information includes feature information of a sample user and feature information of a target object, and the label value is configured to indicate whether the sample user interacts with the target object.

At step 202, one-hot coding feature output by each of the one-hot coding units is obtained by inputting the feature information of the target object into the plurality of one-hot coding units respectively.

As illustrated in FIG. 3, vᵢ represents original target object feature information of a target object i, and uⱼ represents original sample user feature information of a sample user j. Feature embedding processing is performed on original feature information of one or more target objects and original feature information of one or more sample users, to obtain the feature information of the sample user and the feature information of the target object. It should be noted that in the embodiments of the disclosure, one graph generator is defined for each piece of sample feature information, i.e., n=Nᵥ+Nᵤ in FIG. 3, which is a total amount of the sample feature information. The feature information of the target object is input to n one-hot coding units respectively to obtain the one-hot coding feature output by each one-hot coding unit.

The sample feature information can be sample feature information h₁⁽⁰⁾ . . . h_{N}_{ᵥ}_{+N}_{ᵤ}⁽⁰⁾ obtained by transforming discrete original feature information into a dense space through feature embedding process, in which hₘ⁽⁰⁾, m ∈ [1, 2, . . . , Nᵥ+Nᵤ] represents the m^{th} sample feature information, Nᵥ is an amount of the feature information of the target object, and Nᵤ is an amount of the feature information of the sample user.

At step 203, an output result of each of the graph generators is obtained by inputting the one-hot coding feature output by each of the plurality of one-hot coding units into a corresponding graph generator.

It should be noted that an output result of a graph generator m is a row of feature m in a first adjacent matrix Aᵢ⁽¹⁾, i.e., the m^{th} row of the adjacent matrix Aᵢ⁽¹⁾, in which m ∈ [1, 2, . . . , Nᵥ+Nᵤ]. Optionally, an equation for obtaining an output result of a Multilayer Perceptron (MLP) graph generator m may be referred to as follows:

[Aᵢ⁽¹⁾]_{m:}=MLP_{W}_{ₐ}([h₁⁽⁰⁾ . . . h_{N}_{ᵥ}⁽⁰⁾, one−hot(m)])

At step 204, a first adjacent matrix for feature interaction is obtained by splicing the output result of each of the graph generator.

That is, the output results [A ᵢ⁽¹⁾]_{m:} of the n graph generators are spliced to obtain the (Nᵥ+Nᵤ)×(Nᵥ+Nᵤ) first adjacent matrix Aᵢ₍₁₎ for feature interaction, which is exclusive to the target object i.

At step 205, iteration is performed on the first adjacent matrix, and the first adjacent matrix and one or more adjacent matrixes obtained after the iteration are determined as the plurality of adjacent matrixes.

It is noted that, in order to model higher-order feature interactions, there may be a plurality of graph neural network units. Each of the graph neural network units may correspond to one adjacent matrix. Therefore, in an implementation, an iterative equation is provided for the adjacent matrix. An adjacent matrix corresponding to any layer of graph neural network unit can be generated based on the first adjacent matrix. The iterative equation for the adjacent matrix can be designed with reference to the following procedure.

Firstly, the adjacent matrix Āᵢ⁽¹⁾ (Āᵢ⁽¹⁾=Aᵢ⁽¹⁾) is modified by:

\hat{A}ᵢ^{(l)}=sparsify(normalize(A̅ᵢ^{(l)}),K)

where normalize(▪)is min-max normalization that is used to ensure that elements in the adjacent matrix are located in a range from 0 to 1. In addition, in order to prevent the feature interactions with low correlation from negatively affecting the prediction result, sparsify(▪, K) is used to retain the maximum K elements in the adjacent matrix and set the rest elements to 0. Meanwhile, since the feature interactions satisfy the commutative law, the symmetry of the adjacent matrix can be ensured in the following way:

\tilde{A}ᵢ^{(l)}=((\hat{A}ᵢ^{(l)})^{T}+Âᵢ^{(l)})/2

On this basis, the iterative equation is proposed as follows:

Aᵢ^{(l)}=normalize(mask((\tilde{A}ᵢ^{(l-1)}·Ãᵢ⁽¹⁾), Ãᵢ^{(l-1)}))

Taking the embodiment shown in FIG. 3 as an example, an adjacent matrix Aᵢ⁽²⁾ corresponding to a graph neural network unit 2 can be obtained by the iterative equation based on the first adjacent matrix Aᵢ⁽¹⁾.

At step 206, high-order feature information output by each graph neural network unit is obtained using the plurality of graph neural network units, according to the sample feature information and the plurality of adjacent matrixes.

In some embodiments of the disclosure, the plurality of graph neural network units are used for performing feature interaction according to the sample feature information and the plurality of adjacent matrixes, to update the state of the sample feature information, to obtain the high-order feature information output by each graph neural network unit.

As an example, a first graph neural network unit is used to determine a first neighboring feature of the sample feature information based on the corresponding first adjacent matrix Aᵢ⁽¹⁾, and the sample feature information and the first neighboring feature are fused to obtain the higher-order feature information hₘ⁽¹⁾ output by the first graph neural network unit.

A second graph neural network unit is used to determine a second neighboring feature of the sample feature information based on a corresponding adjacent matrix Aᵢ⁽²⁾, and the higher-order feature information hₘ⁽¹⁾ output by the first graph neural network unit and the second neighboring feature are fused, to obtain higher-order feature information hₘ⁽²⁾ output by the second graph neural network unit. Similarly, the l^{th} graph neural network unit is used to determine the l^{th} neighboring feature of the sample feature information based on a corresponding adjacent matrix, and the higher-order feature information hₘ^{(l-1)} output by the l−1^{th} graph neural network unit is fused with the l^{th} neighboring feature, to obtain the higher-order feature information hₘ^{(l)} output by the l^{th} graph neural network unit, in which 1<l≤N, N is the number of graph neural network units. The above processes are repeated until the higher-order feature information output by all graph neural network units are obtained. It should be noted that the embodiment shown in FIG. 3 takes two graph neural network units as an example, which does not constitute a limitation on the number of graph neural network units in the disclosure.

In some embodiments of the disclosure, the high-order feature information hₘ^{(l)} output by the l^{th} graph neural network unit can be referred to the following equation:

hₘ^{(l)}=hₘ^{(l-1)}⊙[Σₙ₌₁^{N}^{ᵥ}^{+N}^{ᵤ}[A^{(l)]}ₘₙW_{g}^{(l-1)}hₙ⁽⁰⁾]

where, W_{g}^{(l-1)} is a learnable parameter.

At step 207, a click rate prediction value of the sample user on the target object is obtained using the prediction unit, according to the higher-order feature information output by each graph neural network unit.

In some embodiments of the disclosure, the high-order feature information output by each graph neural network unit is fused, and the prediction unit is used to obtain the click rate prediction value of the sample user on the target object based on a final representation of the sample feature information obtained through the fusion.

At step 208, the click rate prediction model is trained according to the label value and the click rate prediction value.

In the embodiment of the disclosure, step 201 and step 208 may be realized in any one of the embodiments of the disclosure, which is not limited in the disclosure and will not be repeated.

By implementing the embodiments of the disclosure, the adjacent matrixes for feature interaction of the target object are generated based on the hypernetwork module. According to the adjacent matrixes, the plurality of graph neural network units are used for high-order feature interaction. Click rates are predicted based on the high-order feature information, and the click rate prediction model is trained based on the click rates. Therefore, the click rate prediction accuracy of the click rate prediction model can be rapidly improved under the few-short learning condition, to improve the prediction accuracy of the rate of the user clicking on the target object and to alleviate the cold-start problem in the click rate prediction task to some extent. Effective recommendations can be subsequently provided to the user based on the click rate prediction value to improve the user experience.

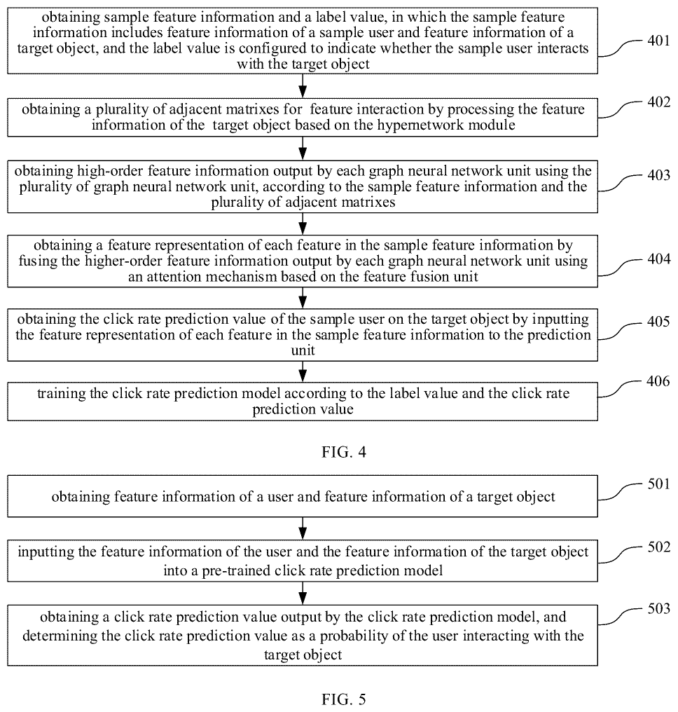

FIG. 4 is a flowchart of a method for training a click rate prediction model according to an embodiment of the disclosure. The prediction module includes a plurality of graph neural network units, a feature fusion unit and a prediction unit, a number of the graph neural network units is the same as a number of a plurality of adjacent matrixes, and each graph neural network unit corresponds to one of the plurality of adjacent matrixes. As illustrated in FIG. 4, the method for training a click rate prediction model includes but is not limited to the following steps.

At step 401, sample feature information and a label value are obtained, in which the sample feature information includes feature information of a sample user and feature information of a target object, and the label value is configured to indicate whether the sample user interacts with the target object.

At step 402, a plurality of adjacent matrixes for feature interaction are obtained by processing the feature information of the target object based on the hypernetwork module.

At step 403, high-order feature information output by each graph neural network unit is obtained by using the plurality of graph neural network units, according to the sample feature information and the plurality of adjacent matrixes.

At step 404, a feature representation of each feature in the sample feature information is obtained by fusing the higher-order feature information output by each graph neural network unit using an attention mechanism based on the feature fusion unit.

Optionally, the feature representation Ĥₘ of the m^{th} feature in the sample feature information may be obtained by fusing the high-order feature information (hₘ⁽⁰⁾, . . . , hₘ^{(N}^{ₗ₎}) output by respective graph neural network units using the attention mechanism via the following equation:

attention(Q, K, V)=softmax(QK^{T}/\sqrt{N^{d}})V

headₕ=attention(W_{q,h}Hₘ, W_{k,h}Hₘ, W_{v,h}Hₘ)

Ĥₘ=[head₁, . . . , head_{N}_{ₕ}]

where, N^{d} is the number of row vectors in Q, Nₕ is the number of heads, Hₘ=[hₘ⁽⁰⁾; . . . ;hₘ^{(N}^{ₗ₎}], Nₗ is the number of layers of the graph neural network, i.e., the number of graph neural network units. Each graph neural network unit is a layer of the graph neural network.

At step 405, a click rate prediction value of the sample user on the target object is obtained by inputting the feature representation of each feature in the sample feature information to the prediction unit.

In a possible implementation, the prediction unit may use a first multilayer perceptron (MLP), i.e., MLP_{W}_{_{c,1}} which uses a parameter W_{c,1} to evaluate a weight of the feature representation of each feature in the sample feature information:

[c₁, . . . , c_{N}_{ᵥ}_{+N}_{ᵤ}]=sigmoid (MLP_{W}_{_{c,1}}(Ĥ₁, . . . , Ĥ_{N}_{ᵥ}_{+N}_{ᵤ}))

A second MLP, i.e., MLP_{W}_{_{c,2}} which uses a parameter W_{c,2}, is used to score the feature representation of each feature in the sample feature information and to perform weighted summation, to obtain the click rate prediction value ŷᵢⱼ of the sample user on the target object:

$${\hat{y}}_{ij} = {\sum }_{m = 1}^{{N}_{v} + {N}_{u}} {c}_{m} \cdot {MLP}_{{W}_{c , 2}} ( {\hat{H}}_{m} )$$

Where, cₘ is a weight of the feature representation of the m^{th} feature in the sample feature information.

At step 406, the click rate prediction model is trained according to the label value and the click rate prediction value.

In the embodiments of the disclosure, steps 401-403, and step 406 may be realized in any one of the embodiments of the disclosure, which is not limited in the disclosure and will not be repeated.

By implementing the embodiments of the disclosure, the adjacent matrixes for feature interaction of the target object, i.e., the feature interaction patterns exclusive to the target object, can be generated based on the hypernetwork module. According to the adjacent matrixes, a plurality of graph neural network units are used for high-order feature interaction. The attention mechanism is used to fuse the high-order feature information output by the plurality of graph neural network units, then click rates are predicted, and the click rate prediction model is further trained. Therefore, the click rate prediction accuracy of the click rate prediction model can be rapidly improved under the few-short learning condition, to improve the prediction accuracy of the rate of the user clicking on the target object and to alleviate the cold-start problem in the click rate prediction task to some extent. Effective recommendations can be subsequently provided to the user based on the click rate prediction value to improve the user experience.

The disclosure also provides a click rate prediction method. FIG. 5 is a flowchart of a click rate prediction method according to an embodiment of the disclosure. It is noted that the click rate prediction method according to the embodiments of the disclosure may be performed by a click rate prediction apparatus according to the embodiments of the disclosure, which may be configured on an electronic device. As illustrated in FIG. 5, the click rate prediction method may include, but is not limited to, the following steps.

At step 501, feature information of a user and feature information of a target object are obtained.

At step 502, the feature information of the user and the feature information of the target object are input into a pre-trained click rate prediction model.

The click rate prediction model is obtained by training using the method for training a click rate prediction model according to any of the above embodiments, which will not be repeated herein.

At step 503, a click rate prediction value output by the click rate prediction model is obtained, and the click rate prediction value is determined as a probability of the user interacting with the target object.

By implementing the embodiments of the disclosure, an optimal feature interaction pattern exclusive to the target object can be obtained through the pre-trained click rate prediction model. The click rate can be predicted based on the feature interaction pattern, to improve the accuracy of the click rate prediction value under the few-short learning condition. Effective recommendations can be provided to the user based on the click rate prediction value, which can improve the user experience.

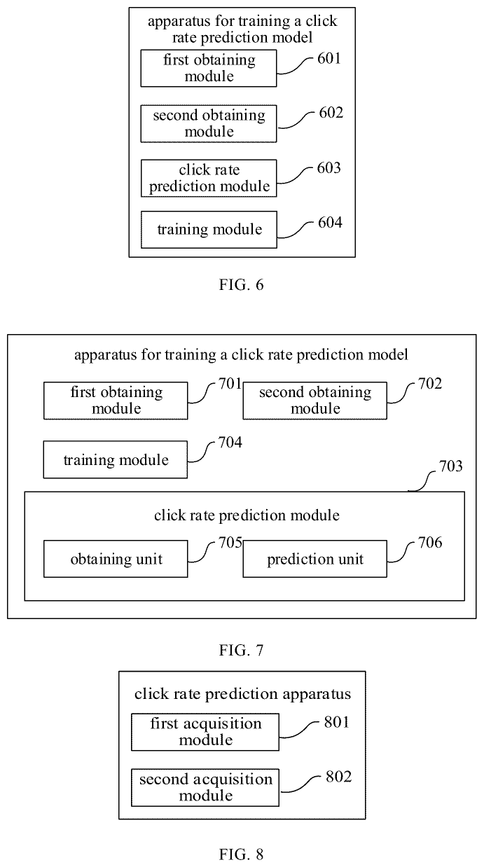

FIG. 6 is a block diagram of an apparatus for training a click rate prediction model according to an embodiment of the disclosure. The click rate prediction model includes a hypernetwork module and a prediction module. As illustrated in FIG. 6, the apparatus includes: a first obtaining module 601, a second obtaining module 602, a click rate prediction module 603, and a training module 604.

The first obtaining module 601 is configured to obtain sample feature information and a label value, in which the sample feature information includes feature information of a sample user and feature information of a target object, and the label value is configured to indicate whether the sample user interacts with the target object.

The second obtaining module 602 is configured to obtain a plurality of adjacent matrixes for feature interaction by processing the feature information of the target object based on the hypernetwork module.

The click rate prediction module 603 is configured to obtain a click rate prediction value of the sample user on the target object using the prediction module, according to the sample feature information and the plurality of adjacent matrixes.

The training module 604 is configured to train the click rate prediction model according to the label value and the click rate prediction value.

In some embodiments of the disclosure, the hypernetwork module includes a plurality of one-hot coding units and graph generators corresponding to f the one-hot coding units respectively. The second obtaining module 602 is configured to: obtain an one-hot coding feature output by each of the one-hot coding units by inputting the feature information of the target object into the plurality of one-hot coding units respectively; obtain an output result of each of the graph generators by inputting the one-hot coding feature output by each of the one-hot coding units into a corresponding graph generator; obtain a first adjacent matrix for feature interaction by splicing the output result of each of the graph generators; and perform iteration on the first adjacent matrix, and determine the first adjacent matrix and one or more adjacent matrixes obtained after the iteration as the plurality of adjacent matrixes.

In some embodiments of the disclosure, the training module 604 is configured to: calculate a loss function according to the label value and the click rate prediction value; and adjust a model parameter of the hypernetwork module and a model parameter of the prediction module according to the loss function.

Optionally, in some embodiments of the disclosure, the prediction module includes a plurality of graph neural network units and a prediction unit. A number of the graph neural network units is the same as a number of the plurality of adjacent matrixes, and each graph neural network unit corresponds to one of the plurality of adjacent matrixes. As illustrated in FIG. 7, the click rate prediction module 703 includes: an obtaining unit 705 and a prediction unit 706. The obtaining unit 705 is configured to obtain high-order feature information output by each graph neural network unit using the plurality of graph neural network units, according to the sample feature information and the plurality of adjacent matrixes. The prediction unit 706 is configured to obtain the click rate prediction value of the sample user on the target object using the prediction unit, according to the higher-order feature information output by each graph neural network unit. 701-704 in FIG. 7 have the same function and structure as 601-604 in FIG. 6 respectively.

In some embodiments of the disclosure, the prediction unit 706 further includes a feature fusion unit. The prediction unit 706 is configured to: obtain a feature representation of each feature in the sample feature information by fusing the higher-order feature information output by each graph neural network unit using an attention mechanism based on the feature fusion unit; and obtain the click rate prediction value of the sample user on the target object by inputting the feature representation of each feature in the sample feature information to the prediction unit.

In some embodiments of the disclosure, the obtaining unit 705 is configured to: determine a first neighboring feature of the sample feature information using a first graph neural network unit based on a corresponding adjacent matrixes, and fuse the sample feature information and the first neighboring feature, to obtain higher-order feature information output by the first graph neural network unit; determine an l^{th} neighboring feature of the sample feature information using an l^{th} graph neural network unit based on a corresponding adjacent matrix, and fuse the higher-order feature information output by an l−1^{th} graph neural network unit with the l^{th} neighboring feature, to obtain higher-order feature information output by the l^{th} graph neural network unit, in which 1<l≤N, N being the number of the graph neural network units; and, repeat the above processes until the higher-order feature information output by all graph neural network units are obtained.

With respect to the apparatus in the above embodiments, the specific manner in which each module performs an operation has been described in detail in the embodiments relating to the method, and will not be described in detail herein.

FIG. 8 is a block diagram of a click rate prediction apparatus according to an embodiment of the disclosure. As illustrated in FIG. 8, the apparatus includes: a first acquisition module 801 and a second acquisition module 802.

The first acquisition module 801 is configured to obtain feature information of a user and feature information of a target object.

The second acquisition module 802 is configured to input the feature information of the user and the feature information of the target object into a pre-trained click rate prediction model, obtain a click rate prediction value output by the click rate prediction model, and determine the click rate prediction value as a probability of the user interacting with the target object, in which the click rate prediction model is obtained by training using the method for training a click rate prediction model according to any one of the above embodiments, which will not be repeated herein.

With respect to the apparatus in the above embodiments, the specific manner in which each module performs an operation has been described in detail in the embodiments relating to the method, and will not be described in detail herein.

According to the embodiments of the disclosure, the disclosure also provides an electronic device, a readable storage medium, and a computer program product.

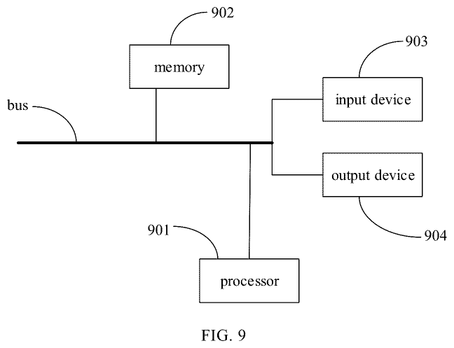

FIG. 9 is a block diagram of an electronic device for implementing the method for training a click rate prediction model or the click rate prediction method according to an embodiment of the disclosure. The electronic device is intended to represent various forms of digital computers, such as laptop computers, desktop computers, workbenches, personal digital assistants, servers, blade servers, mainframe computers, and other suitable computers. The electronic devices may also represent various forms of mobile devices, such as personal digital assistants, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the electronic device includes: one or more processors 901, a memory 902, and interfaces for connecting various components, including a high-speed interface and a low-speed interface. The components are interconnected using different buses and may be mounted on a common main board or otherwise mounted as desired. The processor may process instructions executed within the electronic device, including instructions stored in or on the memory to display graphical information of the GUI on an external input/output device. In other implementations, multiple processors and/or buses may be used together with multiple memories, if desired. Similarly, a plurality of electronic devices can be connected, each providing a part of necessary operations (e.g., acting as a server array, a group of blade servers, or a multiprocessor system). FIG. 9 shows an example of one processor 901.

The memory 902 is the non-transitory computer readable storage medium provided in the disclosure. The memory stores instructions executable by at least one processor, to cause the at least one processor to execute the method for training a click rate prediction model or the click rate prediction method provided by the disclosure. The non-transitory computer readable storage medium of the disclosure stores computer instructions that are used to cause a computer to implement the method for training a click rate prediction model or the click rate prediction method provided by the disclosure.

As a non-transitory computer readable storage medium, the memory 902 can be used to store non-transitory software programs, non-transitory computer executable programs and modules, such as the program instructions/modules corresponding to the method for training a click rate prediction model or the click rate prediction method in the embodiments of the disclosure. The processor 901 executes various functional applications of the server and data processing by running the non-transitory software programs, instructions, and modules stored in the memory 902, i.e., implementing the method for training a click rate prediction model or the click rate prediction method in the method embodiments described above.

The memory 902 may include a program storage area and a data storage area. The program storage area may store an operating system, and applications required by at least one function. The data storage area may store data created based on the use of the electronic device performing the method for training a click rate prediction model or the click rate prediction method. In addition, the memory 902 may include a high-speed random access memory, or a non-transitory memory, such as at least one disk memory device, flash memory device, or other non-transitory solid state memory device. In some embodiments, the memory 902 may include memories that are remotely set relative to the processor 901, and these remote memories may be connected to the electronic device that implements the method for training a click rate prediction model or the click rate prediction method via a network. Examples of the network include, but are not limited to, the Internet, corporate intranets, local area networks, mobile communication networks, and combinations thereof.

The electronic device that implements the method for training a click rate prediction model or the click rate prediction method may also include: an input device 903 and an output device 904. The processor 901, the memory 902, the input device 903, and the output device 904 may be connected via buses or otherwise. For example, the connections in FIG. 9 are implemented by buses.

The input device 903 may receive input numbers or character information, and key signal input related to user settings and functional control for the electronic device, such as a touch screen, a keypad, a mouse, a trackpad, a touchpad, an indicator rod, one or more mouse buttons, trackballs, joysticks, and other input devices. The output device 904 may include a display device, an auxiliary illuminating device (e.g., LED), and a haptic feedback device (e.g., vibration motor), etc. The display device may include, but is not limited to, a Liquid Crystal Display (LCD), a Light Emitting Diode (LED) display, and a plasma display. In some embodiments, the display device may be a touch screen.

Various implementations of the systems and techniques described herein may be implemented in a digital electronic circuit system, an integrated circuit system, an Application Specific Integrated Circuit (ASIC), computer hardware, firmware, software, and/or combinations thereof. These various implementations may include: implemented in one or more computer programs. That is, the disclosure also provides a computer program. When the computer program is executed by the processor, the method for training a click rate prediction model or the click rate prediction method is implemented. The one or more computer programs may be executed and/or interpreted on a programmable system including at least one programmable processor, which may be a dedicated or general-purpose programmable processor that may receive data and instructions from a storage system, at least one input device, and at least one output device, and send the data and instructions to the storage system, the at least one input device, and the at least one output device.

These computing programs (also referred to as programs, software, software applications, or codes) include machine instructions for a programmable processor and may be implemented using high-level procedural and/or object-oriented programming languages, and/or assembly/machine languages. As used herein, the terms “machine-readable medium” and “computer-readable medium” refer to any computer program product, device, and/or apparatus (e.g., disk, Compact Disc Read-Only Memories (CD-ROM), memory, Programmable Logic Device (PLD)) used to provide machine instructions and/or data to a programmable processor, including machine- readable medium that receives machine instructions as machine-readable signals. The term “machine-readable signal” refers to any signal used to provide machine instructions and/or data to the programmable processor.

In order to provide interaction with a user, the systems and techniques described herein may be implemented on a computer having a display device (e.g., a Cathode Ray Tube (CRT) or a Liquid Crystal Display (LCD) monitor) for displaying information to a user; and a keyboard and a pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such background components, middleware components and front-end components. The components of the system may be interconnected by any form or medium of digital data communication (e.g., a communication network). Examples of communication networks include: a Local Area Network (LAN), a Wide Area Network (WAN), the Internet, and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service sys tem to solve the defects of difficult management and poor business expansion in traditional physical hosting and Virtual Private Server (VPS) services. The server may be a server of a distributed system, or a server incorporating a block-chain. It should be understood that the various forms of processes shown above can be used to reorder, add or delete steps. For example, the steps described in the disclosure may be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this disclosure shall be included in the protection scope of this disclosure.

What is claimed is:

1. A method for training a click rate prediction model, wherein the click rate prediction model comprises a hypernetwork module and a prediction module, and the method comprises:
obtaining sample feature information and a label value, wherein the sample feature information comprises feature information of a sample user and feature information of a target object, and the label value is configured to indicate whether the sample user interacts with the target object;
obtaining a plurality of adjacent matrixes for feature interaction by processing the feature information of the target object based on the hypernetwork module;
obtaining a click rate prediction value of the sample user on the target object using the prediction module, according to the sample feature information and the plurality of adjacent matrixes; and
training the click rate prediction model according to the label value and the click rate prediction value.

2. The method of claim 1, wherein the hypernetwork module comprises a plurality of one-hot coding units and graph generators corresponding to the one-hot coding units respectively, and obtaining the plurality of adjacent matrixes for feature interaction by processing the feature information of the target object based on the hypernetwork module comprises:
obtaining an one-hot coding feature output by each of the one-hot coding units by inputting the feature information of the target object into the plurality of one-hot coding units respectively;
obtaining an output result of each of the graph generators by inputting the one -hot coding feature output by each of the plurality of one-hot coding units into a corresponding graph generator;
obtaining a first adjacent matrix for feature interaction by splicing the output result of each of the graph generators; and
performing iteration on the first adjacent matrix, and determining the first adjacent matrix and one or more adjacent matrixes obtained after the iteration as the plurality of adjacent matrixes.

3. The method of claim 1, wherein the prediction module comprises a plurality of graph neural network units and a prediction unit, a number of the graph neural network units is the same as a number of the plurality of adjacent matrixes, and each graph neural network unit corresponds to one of the plurality of adjacent matrixes, and obtaining the click rate prediction value of the sample user on the target object using the prediction module according to the sample feature information and the plurality of adjacent matrixes comprises:
obtaining high-order feature information output by each graph neural network unit using the plurality of graph neural network unit, according to the sample feature information and the plurality of adjacent matrixes; and
obtaining the click rate prediction value of the sample user on the target object using the prediction unit, according to the higher-order feature information output by each graph neural network unit.

4. The method of claim 3, wherein the prediction module further comprises a feature fusion unit, and obtaining the click rate prediction value of the sample user on the target object using the prediction unit according to the higher-order feature information output by each graph neural network unit comprises:
obtaining a feature representation of each feature in the sample feature information by fusing the higher-order feature information output by each graph neural network unit using an attention mechanism based on the feature fusion unit; and
obtaining the click rate prediction value of the sample user on the target object by inputting the feature representation of each feature in the sample feature information to the prediction unit.

5. The method of claim 3, wherein obtaining the high-order feature information output by each graph neural network unit using the plurality of graph neural network units, according to the sample feature information and the plurality of adjacent matrixes comprises:
determining a first neighboring feature of the sample feature information using a first graph neural network unit based on a corresponding adjacent matrix, and fusing the sample feature information and the first neighboring feature, to obtain higher-order feature information output by the first graph neural network unit;
determining an l^{th} neighboring feature of the sample feature information using an l^{th} graph neural network unit based on a corresponding adjacent matrix, and fusing higher-order feature information output by an l−1^{th} graph neural network unit and the l^{th} neighboring feature, to obtain higher-order feature information output by the l^{th} graph neural network unit, wherein 1<l≤N, N being the number of the graph neural network units; and
repeating the above processes until the higher-order feature information output by all the graph neural network units are obtained.

6. The method of claim 1, wherein training the click rate prediction model according to the label value and the click rate prediction value comprises:
calculating a loss function according to the label value and the click rate prediction value; and
adjusting a model parameter of the hypernetwork module and a model parameter of the prediction module according to the loss function.

7. A click rate prediction method, comprising:
obtaining feature information of a user and feature information of a target object;
inputting the feature information of the user and the feature information of the target object into a pre-trained click rate prediction model, wherein the click rate prediction model is obtained by training using the method as claimed in claim 1; and
obtaining a click rate prediction value output by the click rate prediction model, and determining the click rate prediction value as a probability of the user interacting with the target object.

8. An electronic device, comprising:
at least one processor; and
a memory communicatively coupled to the at least one processor; wherein,
the memory stores instructions executable by the at least one processor, when the instructions are executed by the at least one processor, the at least one processor is caused to perform a method for training a click rate prediction model, the method comprising:
obtaining sample feature information and a label value, wherein the sample feature information comprises feature information of a sample user and feature information of a target object, and the label value is configured to indicate whether the sample user interacts with the target object;
obtaining a plurality of adjacent matrixes for feature interaction by processing the feature information of the target object based on the hypernetwork module;
obtaining a click rate prediction value of the sample user on the target object using the prediction module, according to the sample feature information and the plurality of adjacent matrixes; and
training the click rate prediction model according to the label value and the click rate prediction value.

9. The electronic device of claim 8, wherein the hypernetwork module comprises a plurality of one-hot coding units and graph generators corresponding to the one-hot coding units respectively, and obtaining the plurality of adjacent matrixes for feature interaction by processing the feature information of the target object based on the hypernetwork module comprises:
obtaining an one-hot coding feature output by each of the one-hot coding units by inputting the feature information of the target object into the plurality of one-hot coding units respectively;
obtaining an output result of each of the graph generators by inputting the one-hot coding feature output by each of the plurality of one-hot coding units into a corresponding graph generator;
obtaining a first adjacent matrix for feature interaction by splicing the output result of each of the graph generators; and
performing iteration on the first adjacent matrix, and determining the first adjacent matrix and one or more adjacent matrixes obtained after the iteration as the plurality of adjacent matrixes.

10. The electronic device of claim 8, wherein the prediction module comprises a plurality of graph neural network units and a prediction unit, a number of the graph neural network units is the same as a number of the plurality of adjacent matrixes, and each graph neural network unit corresponds to one of the plurality of adjacent matrixes, and obtaining the click rate prediction value of the sample user on the target object using the prediction module according to the sample feature information and the plurality of adjacent matrixes comprises:
obtaining high-order feature information output by each graph neural network unit using the plurality of graph neural network unit, according to the sample feature information and the plurality of adjacent matrixes; and
obtaining the click rate prediction value of the sample user on the target object using the prediction unit, according to the higher-order feature information output by each graph neural network unit.

11. The electronic device of claim 10, wherein the prediction module further comprises a feature fusion unit, and obtaining the click rate prediction value of the sample user on the target object using the prediction unit according to the higher-order feature information output by each graph neural network unit comprises:
obtaining a feature representation of each feature in the sample feature information by fusing the higher-order feature information output by each graph neural network unit using an attention mechanism based on the feature fusion unit; and
obtaining the click rate prediction value of the sample user on the target object by inputting the feature representation of each feature in the sample feature information to the prediction unit.

12. The electronic device of claim 10, wherein obtaining the high-order feature information output by each graph neural network unit using the plurality of graph neural network units, according to the sample feature information and the plurality of adjacent matrixes comprises:
determining a first neighboring feature of the sample feature information using a first graph neural network unit based on a corresponding adjacent matrix, and fusing the sample feature information and the first neighboring feature, to obtain higher-order feature information output by the first graph neural network unit;
determining an l^{th} neighboring feature of the sample feature information using an l^{th} graph neural network unit based on a corresponding adjacent matrix, and fusing higher-order feature information output by an l−1^{th} graph neural network unit and the l^{th} neighboring feature, to obtain higher-order feature information output by the l^{th} graph neural network unit, wherein 1<l≤N, N being the number of the graph neural network units; and
repeating the above processes until the higher-order feature information output by all the graph neural network units are obtained.

13. The electronic device of claim 8, wherein training the click rate prediction model according to the label value and the click rate prediction value comprises:
calculating a loss function according to the label value and the click rate prediction value; and
adjusting a model parameter of the hypernetwork module and a model parameter of the prediction module according to the loss function.

14. An electronic device, comprising:
at least one processor; and
a memory communicatively coupled to the at least one processor; wherein,
the memory stores instructions executable by the at least one processor, when the instructions are executed by the at least one processor, the at least one processor is caused to perform the method for training a click rate prediction model of claim 7.

15. A non-transitory computer-readable storage medium having computer instructions stored thereon, wherein the computer instructions are configured to cause a computer to perform a method for training a click rate prediction model, the method comprising:
obtaining sample feature information and a label value, wherein the sample feature information comprises feature information of a sample user and feature information of a target object, and the label value is configured to indicate whether the sample user interacts with the target object;
obtaining a plurality of adjacent matrixes for feature interaction by processing the feature information of the target object based on the hypernetwork module;
obtaining a click rate prediction value of the sample user on the target object using the prediction module, according to the sample feature information and the plurality of adjacent matrixes; and
training the click rate prediction model according to the label value and the click rate prediction value.

16. The non-transitory computer-readable storage medium of claim 15, wherein the hypernetwork module comprises a plurality of one-hot coding units and graph generators corresponding to the one-hot coding units respectively, and obtaining the plurality of adjacent matrixes for feature interaction by processing the feature information of the target object based on the hypernetwork module comprises:
obtaining an one-hot coding feature output by each of the one-hot coding units by inputting the feature information of the target object into the plurality of one-hot coding units respectively;
obtaining an output result of each of the graph generators by inputting the one -hot coding feature output by each of the plurality of one-hot coding units into a corresponding graph generator;
obtaining a first adjacent matrix for feature interaction by splicing the output result of each of the graph generators; and
performing iteration on the first adjacent matrix, and determining the first adjacent matrix and one or more adjacent matrixes obtained after the iteration as the plurality of adjacent matrixes.

17. The non-transitory computer-readable storage medium of claim 15, wherein the prediction module comprises a plurality of graph neural network units and a prediction unit, a number of the graph neural network units is the same as a number of the plurality of adjacent matrixes, and each graph neural network unit corresponds to one of the plurality of adjacent matrixes, and obtaining the click rate prediction value of the sample user on the target object using the prediction module according to the sample feature information and the plurality of adjacent matrixes comprises:
obtaining high-order feature information output by each graph neural network unit using the plurality of graph neural network unit, according to the sample feature information and the plurality of adjacent matrixes; and
obtaining the click rate prediction value of the sample user on the target object using the prediction unit, according to the higher-order feature information output by each graph neural network unit.

18. The non-transitory computer-readable storage medium of claim 17, wherein the prediction module further comprises a feature fusion unit, and obtaining the click rate prediction value of the sample user on the target object using the prediction unit according to the higher-order feature information output by each graph neural network unit comprises:
obtaining a feature representation of each feature in the sample feature information by fusing the higher-order feature information output by each graph neural network unit using an attention mechanism based on the feature fusion unit; and
obtaining the click rate prediction value of the sample user on the target object by inputting the feature representation of each feature in the sample feature information to the prediction unit.

19. The non-transitory computer-readable storage medium of claim 17, wherein obtaining the high-order feature information output by each graph neural network unit using the plurality of graph neural network units, according to the sample feature information and the plurality of adjacent matrixes comprises:
determining a first neighboring feature of the sample feature information using a first graph neural network unit based on a corresponding adjacent matrix, and fusing the sample feature information and the first neighboring feature, to obtain higher-order feature information output by the first graph neural network unit;
determining an l^{th} neighboring feature of the sample feature information using an l^{th} graph neural network unit based on a corresponding adjacent matrix, and fusing higher-order feature information output by an l−1^{th} graph neural network unit and the l^{th} neighboring feature, to obtain higher-order feature information output by the l^{th} graph neural network unit, wherein 1<l≤N, N being the number of the graph neural network units; and
repeating the above processes until the higher-order feature information output by all the graph neural network units are obtained.

20. The non-transitory computer-readable storage medium of claim 15, wherein training the click rate prediction model according to the label value and the click rate prediction value comprises:
calculating a loss function according to the label value and the click rate prediction value; and
adjusting a model parameter of the hypernetwork module and a model parameter of the prediction module according to the loss function.
